(19) United States
(12) Patent Application Publication
(10) Pub. No.: US 2021/0240940 A1
(43) Pub. Date: Aug. 5, 2021

(54) SCALABLE METHOD AND SYSTEM FOR BUILDING INTERACTIVE LOGIC

(71) Applicant: Lovingly, LLC, Hopewell Junction, NY (US)

(72) Inventors: Joseph Vega, Hopewell Junction, NY (US); Kenny Garland, Poughkeepsie, NY (US); Daniela Virginia Marquez, Poughkeepsie, NY (US); Marque Nolan Staneluis, Lagrangeville, NY (US); Dennis Park-Rodriguez, Hopewell Junction, NY (US); Ryan Wesley A. Lowe, Cold Spring, NY (US); Lakshmi Pillai, Fishkill, NY (US); James Craig Rosenthal, Newburgh, NY (US); Matthew Zangen, New Paltz, NY (US); Kaitlin Schupp Gage, Kingston, NY (US); Danielle Sarah Gorton, Beacon, NY (US); Mahima Thomas, Wilton, CT (US)

(21) Appl. No.: 17/159,937

(22) Filed: Jan. 27, 2021

Related U.S. Application Data
(60) Provisional application No. 62/968,547, filed on Jan. 31, 2020.

(51) Int. Cl. G06F 40/35; G06F 16/958; G06Q 30/06

(52) U.S. Cl. CPC G06F 40/35; G06Q 30/0631; G06F 16/986

(57) ABSTRACT

A system for interacting with a user includes a processor operatively coupled to a storage device having a data structure defining an odyssey map recorded therein. The data structure includes a plurality of different node types, each node being associated with an indication of node type, and further includes a route defined in terms of an ordered sequence of nodes including a current node, a through node, and a next node. In the embodiment, the traversal of the route by a user interacting with the plurality of nodes concludes with a presentation of a recommendation to the user. The data structure further includes instructions for presenting contents of a node via a human interface device.

### CROSS REFERENCE TO RELATED APPLICATION

This application claims the benefit of 62/968,547 filed on Jan. 31, 2020 which is incorporated by reference as if fully set forth.

### BACKGROUND

The present invention generally relates to providing a dynamically interactive method and system for interacting with a user that can guide commerce and conversation through natural language interaction. More particularly, the invention relates to interactive process for making suggestions, making product or service recommendations, or facilitating a purchase of such products or services, that involves a user taking part in a series of natural language interactions.

Conventional software interaction experiences, including those pertaining to e-commerce, corporate productivity, service-provision, and the like, are commonly presented as static web or application interfaces that don't change, respond, or assist a user with respect to an emotional state or intention that they may have. For example, conventional interactions on websites, applications, and other software services generally remain the same regardless of the mood or emotional state of the user. This state of affairs becomes problematic for users who seek to have their interaction with software interfaces reflect their emotional states or goals because the static framework of conventional interaction often poorly corresponds to the purposes of the interaction with the software and the fulfillment of the emotional goals that the users may have.

Accordingly, for the foregoing reasons, there is a need for a system and method for ascertaining a user's emotional goal, desires, and intentions and providing an interactive and dynamically changing experience of interfacing with the system that can provide recommendations aimed at the fulfillment of that user's goal. Likewise, there is a need for such a system and method to be responsive to and based on a user's emotional goal, desires, intentions, and previous interactions.

### SUMMARY

In accordance with an embodiment of the present invention, a system for interacting with a user includes a processor operatively coupled to a storage device having a data structure defining an odyssey map recorded therein. The data structure includes a plurality of different node types, each node being associated with an indication of node type, and further includes a route defined in terms of an ordered sequence of nodes including a current node, a through node, and a next node. In the embodiment, the traversal of the route by a user interacting with the plurality of nodes concludes with a presentation of a recommendation to the user. The data structure further includes instructions for presenting contents of a node via a human interface device.

Another embodiment of the present invention provides a non-transitory computer readable storage medium having a computer readable program for creating an odyssey map traversable by a user, such that the computer readable program when executed on a computing device causes the computing device to generate a data structure. The data structure includes a plurality of different node types, each node being associated with an indication of node type. The data structure further includes a route defined in terms of an ordered sequence of nodes including a current node, a through node, and a next node, such that a traversal of the route by a user interacting with the plurality of nodes concludes with a presentation of a recommendation to the user. The data structure also includes instructions for presenting contents of a node via a human interface device.

In accordance with an embodiment of the present invention, a system for interacting with a user includes a storage device with a data structure defining an odyssey map recorded therein. The data structure includes a plurality of different node types, each node being associated with a human readable value or machine readable value, an indication of type, and an identification of its parent value, as well as a route defined in terms of an ordered sequence of a current node, a through node, and a next node, wherein a traversal of the route by a user interacting with the plurality of nodes concludes with a presentation of a recommendation to the user. The data structure also includes instructions for rendering data contents of a node via a human interface device.

In another embodiment, a non-transitory computer readable storage medium includes a data structure representing an odyssey map. The odyssey map has a plurality of different node types, each node being associated with an indication of node type as well as a route defined in terms of an ordered sequence of nodes including a current node, a through node, and a next node. The traversal of the route by a user concludes with a presentation of a recommendation to the user. The odyssey map has at least one of each of a question node, an answer node, and an affirmation node.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1A is a block diagram of a data structure, in accordance with an embodiment of the present invention;

FIG. 1B is a diagram of a data structure for a node, in accordance with an embodiment of the present invention;

FIG. 1C is a diagram of an exemplary JavaScript Object Notation (JSON) file including the information for a node, in accordance with an embodiment of the present invention;

FIG. 2 is an exemplary partial flow diagram of a route and path, in accordance with an embodiment of the present invention;

FIG. 3 is an exemplary partial flow diagram of a traversal of routes of an odyssey map, in accordance with an embodiment of the present invention;

FIGS. 4A-4I respectively depict portions of one exemplary odyssey map, in accordance with an embodiment of the present invention;

FIG. 5 is a schematic diagram of a networked system, in accordance with an embodiment of the present invention; and

FIG. 6 is a schematic diagram of a system, in accordance with an embodiment of the present invention.

### DETAILED DESCRIPTION

In the Summary above and in this Detailed Description, and the claims below, and in the accompanying drawings, reference is made to particular features of various embodiments of the invention. It is to be understood that the disclosure of the various versions of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention relate to systems and methods of building an interactive logic of a data structure defining an odyssey pattern of interrelated nodes. The odyssey pattern can be a map that can be traversed by a user interacting with the nodes through a user interface to arrive at a suggestion or recommendation presented to the user by the system.

The various embodiments of the systems and methods described herein involve the creation of an odyssey pattern, which can be understood to be a map all possible paths to be taken along a decision tree, and includes nodes of several core/basic types (e.g., question nodes, answer nodes, and affirmation nodes) that take a user through the stages of an iterative and interactive natural language question-response process. It is noted that there can be additional node types defined that provide additional functionality (e.g., process nodes, expression nodes, etc.). The terms odyssey pattern and odyssey map may be used interchangeably herein. From the system perspective, the nodes can be understood to be logical elements of a data structure recorded in a non-transitory computer readable medium between which relationships can be defined to generate the structure of the odyssey pattern. From the user perspective, the process of traversing the odyssey pattern can be represented by a sequence or series of audio/visual interface interactions that can be broken up into steps or stages. For example, in the case of a visual user interface interaction, the traversal of several nodes can be grouped into “steps” that can each be generally represented as a digital page with interactive elements via which the user can provide input or feedback (e.g., a step in the odyssey map traversal process can be represented by a page prompting a user with a question (i.e., a question node of the odyssey pattern data structure), where the user can enter, or select a response/answer (i.e., an answer node of the odyssey pattern data structure), after which the user may be presented with an affirmation (i.e., a node of the odyssey pattern data structure)).

Each node in the odyssey pattern/map is understood to be an immutable atomic object (i.e., a basic building block of the data structure of the system) and can be connected to another node to create a route. The route can be understood to be a path which a user will traverse by interacting with the nodes of the system. Starting with a root node, each node can be treated as either a “current” node, a “through” node, or a “next” node to define the route that the user will traverse. In this manner, any path/route along the map can be represented by a three-column routing table by referencing the respective categorizations of the nodes as “current”, “through”, and “next”.

That is to say that the definition of particular nodes as “current”, “through”, or “next” is sufficient to generate a route for a user and generate the entirety of an odyssey map that a user can traverse depending on the user's selections, entries, or interactions. Accordingly, in the various embodiments described herein, the odyssey pattern data structure can be such that any and all relationships between the nodes and the traversable paths thereof can be sufficiently defined with reliance only on the categorization of nodes as “current”, “through”, or “next”. In this manner, a user can be guided from a root node along a path involving natural language questions, inputs, selections and choices to arrive at a product/service governed solely by the definition of the nodes and the three-category (current, through, next) relationship between them.

To address and handle numerous variations of the kinds of interactions and response that can occur during an interactive experience of a user communicating with a system, the various embodiments of the present invention include a logical pattern with rules that can connect any phrase or communication with any available option to drive the user to the next phrase or stage in the communication. Each phrase or each stage in the communication can be designed to either give feedback or to collect information. The information can be organized such that each data association between nodes can be described in terms of a current position with a vector to another position through a path.

The path can be understood as 1 through n choices/options that can follow from the current position (i.e., possible branches stemming from the current node in the odyssey map). All the positions and possible choices (e.g., selections or entries that can be made by a user) in the odyssey pattern are considered to be “nodes” in the system and in the data structure. In the various embodiments, each node includes at least an ID, a value, and a type. Additionally, each node is connected to another node through a third node as defined by a relationship table (e.g., a map_edges table). While an expandable variety of nodes are contemplated in the different embodiments of the present inventions, in a preferred implementation, the plurality of nodes can include question nodes, answer nodes, affirmation nodes, process nodes (e.g., a search), and expression nodes (e.g., a function). The ID, value, and type attributes of the nodes will be described in more detail below, as will the connections/associations between nodes.

The embodiments of the present invention can be implemented on a variety of different platforms including implementation as a web site, a computer application, a mobile device application, a smart speaker application, a telephone service, etc. In an embodiment implemented as an application displayed via a visual interface such as a website displayed on a monitor or an application displayed on a smart phone screen, in a practical sense, the application and its interaction can be dived into modules and a user's interaction with it can be divided into steps/stages. Each module of the application can be given a map ID as a parent container. Further, each page presented to a user interacting with the application can be considered to be a step in the interactive process and can encapsulate all of the values (e.g. map_edges values) representing the possible decision tree branches (e.g., edges of the odyssey map) associated with that step. In the embodiment implemented as an application, the display layer can identify the template that should be used for the presentation of the step in a user-perceivable fashion (e.g., audio/video format) based on a token value sent from a table containing form type (e.g. a form_types table) as it is presented in the encapsulation.

In an embodiment, when the application begins running, it starts by identifying the odyssey map that should be used and presents the assembled data to the front end, either in its entirety or one step at a time, so that it can then be presented to a user. At each current step, the paths, each of which can be understood as a node edge or a node itself, are presented to a user (e.g., displayed). As the user interacts with the system (e.g., by making a selection or entering information) indicating a selection of one of the paths, the system can then route the user to the next node as indicated in a table containing information regarding the map edges (e.g. a map_edges table). Because the interaction can be divided into stages or steps (e.g., an interactive page of a website), each of which may include the traversal of one or more than one node, upon a selection of a path a user can either remain on the same step or move on to the next step in the interactive process. In an embodiment, if the next node is contained in the same step that the user with which the user has interacted, then data or information displayed within the template presented to the user will change. Alternatively, if the next node is part of another step, then the displayed information template will change based on the form type for the next step and the process described in this paragraph may iterate. It should be understood that different steps (e.g., webpages) may have different templates, each with its own layout, appearance, colors, interactive elements, and input fields.

In one exemplary embodiment, the process described above can be contemplated to include a series of questions (i.e., question nodes of the odyssey map) presented to a user and a number of responses (i.e., answer nodes of the odyssey map) provided by a user. If the question is “How are you feeling today?” and the potential answers are “Great”, “Just OK”, “Sad”, “Mad” or “Something Else”, it should be understood that each response/selection can lead to a subsequent step in the iterative interactive natural-language process, such as an affirmation (i.e., an affirmation node of the odyssey map), another question, a combination of both, or another action (e.g., in the case that a step has multiple map edges and nodes contained therein).

In an exemplary embodiment, if the user answered “Great”, then the next node can include the text “Wonderful. Have a great Day!” (e.g., an affirmation node) and end the program, whereas if the answer was “Sad” then the next node traversed by the user can present the text “I'm Sorry” (e.g., an affirmation node) followed by another node presenting the text “How can I Help?” (e.g., a question node) followed by more answers (e.g., answer nodes) which may or may not lead to more steps before finally ending the program. An advantage of the methods and systems described in the embodiments of the present invention is that the data structure of the odyssey pattern is very elastic in that new routes and nodes can be easily added (or removed) at any point in the odyssey map to expand it and tailor it to nearly any conceivable scenario.

It should be understood that each one of the user's interactions (e.g., selections, responses, data entries, etc.) and/or selected values can be stored for future use by the system and can be used to contextualize following nodes and help determine the conclusion of the interactive iterative process. As noted above, while a preferred embodiment of the present invention is implemented as a website, other implementations such as a computer application, a mobile device application, a smart speaker application, a telephone service, an automated phone system, and an interactive customer service system are also contemplated hereby.

A more detailed description of the odyssey pattern is provided as follows. The odyssey pattern can be understood to be a full map of the data structures including all the information from the system traversed by the user. The user can traverse the map via the nodes thereof by making selections, where appropriate, that can decide the subsequent nodes that the user will traverse and the particular route that will be traveled. As the routes are traversed, the application can retain and aggregate these selections to be used at the end of the traversal to be used in the final decision making process at the conclusion of the traversal and the interactive process. The final decision can be achieved by an algorithmic association of the interactions (e.g., selections) made by the user. Alternatively, the embodiments of the systems and methods of the invention can also be fed selections or inputs independently of having them be entered or selected by a user. Accordingly, because the entire odyssey map can be predefined, the system can be fed any or all of the selections/inputs from an external source in order to skip or otherwise forego traversal of certain steps or nodes.

In an embodiment of the present invention, an odyssey map data structure can be understood to include a map, nodes, routes, form types, and associations. In accordance with the embodiment, a map can include an ID, a human-readable name, a description, and a root node. A node can include an ID, a human readable value (which may or may not contain tem plating variables for substitution) or executable syntax or commands, an indication of the node's type (e.g., question, answer, affirmation, process, expression etc.), a parent_id (i.e., a parent value) to associate the node with an overarching concept common to all variants of that node that may have different values but have the same meaning (e.g., a parent_id of “mother” may be associated with nodes having the values “mom”, “mama”, “mommy” etc. which can be understood as aliases of each other; a node including a question of “How can we help you?” may be associated with the same parent_id as a node with the question of “How may we assist you?”). Routes can be understood as a combination of three or more (not necessarily different) node IDs designated as either a “current”, “next”, or “through” node, as well as an order in which they are related/associated between each other (e.g., the order in which choices may appear for a user on a screen). A form type is a value that can be understood as a means of communicating/indicating to the front-end module or aspect of the application how the current node should be encapsulated and presented to the user. An association between nodes is a way of connecting or relating nodes to each other that is not related to the determination of routes for traversal and is a method that allows one node to be classified against another node (e.g., a user may be presented with a selection of messages to choose to go along with a gift that they select dependent on a response the user provided at some point early in the iterative interactive process whereby the selection of messages does not depend on the route subsequently traversed by the user after that early point).

A core concept of the odyssey map data structure and the systems and methods in which it is included, is the definition of an immutable atomic object, called a “node” herein, that is connected to at least one other one of such immutable atomic objects (i.e., nodes). This connection occurs through a path that is called a “route” herein. In this manner, any row in a routing table, such as Table 2 provided below, can connect two nodes together, in accordance with any of a variety of relationships, based entirely upon the position assembly of three node values (i.e., current, through, and next).

TABLE 1

| Through | Current | Next |
|---|---|---|
| 2 | 1 | 3 |
| 4 | 1 | 3 |
| 5 | 1 | 6 |

Because, as noted earlier, some of the node types include those of Questions, Answers, affirmations, Processes, and Expressions, the process of iterative interaction may start with a question node. A question (i.e., a question node) can generally have a finite, but flexible (i.e., changeable at a later time) number N of answers (i.e., an answer node). Each of these answers can provide a path through to the next node which can be another question or an affirmation (i.e., an affirmation node). Thus starting with a question, a user answers it (e.g., by inputting data or making a selection) and moves on to the next node. Accordingly, a user, by answering a question, gets from the “current” node (which in this case happens to be a question node) to the to the “next” node (which can be a question node, affirmation, node etc.) via a “through” node (in this case an answer node). When a user has arrived at an affirmation (i.e., an affirmation node) there is no answer that can be provided. However, the subsequent route that starts at an affirmation node proceeds as follows and in accordance with a routing table such as Table 2 below.

TABLE 2

| Through | Current | Next |
|---|---|---|
| 7 | 6 | 7 |

In this case an affirmation is asserted/presented to a user which is then automatically followed by a No Operation (i.e. a noop) step which takes the user to the “next” node from the “current” node (which in this case is an affirmation node) “through” the “next” node. In other words, as shown in the table, the “through” and “next” node is the same node, so that the user gets to the next node through the same node at which the user is supposed to arrive.

In the various embodiments, the entire odyssey map can be generated and rendered all at once or given/presented one step at a time. In an embodiment implemented as a web site, each page in the process can be understood as a step or stage whose “shape” (which may be government by templates which can include a theme, a number of nodes, color schemes, answers, layouts, and manner in which information is presented) and nodes are defined by the information in the odyssey map data structure. In an exemplary embodiment, once at a question node with answers (i.e., answer nodes) associated with it, a user can proceed to the next step by selecting one of the available choices. Once a choice is selected, the user will progress to the next node and the system will collect the user's answer (including its respective ID, parent_id, and other attributes). In an embodiment, if the next node is an affirmation node, the user can just be presented with a message (as if one was engaging in a conversation) before moving on to the next step, which can be any other node type except an answer node and can either be progressed to by manual intervention by the user or through the use of a timer.

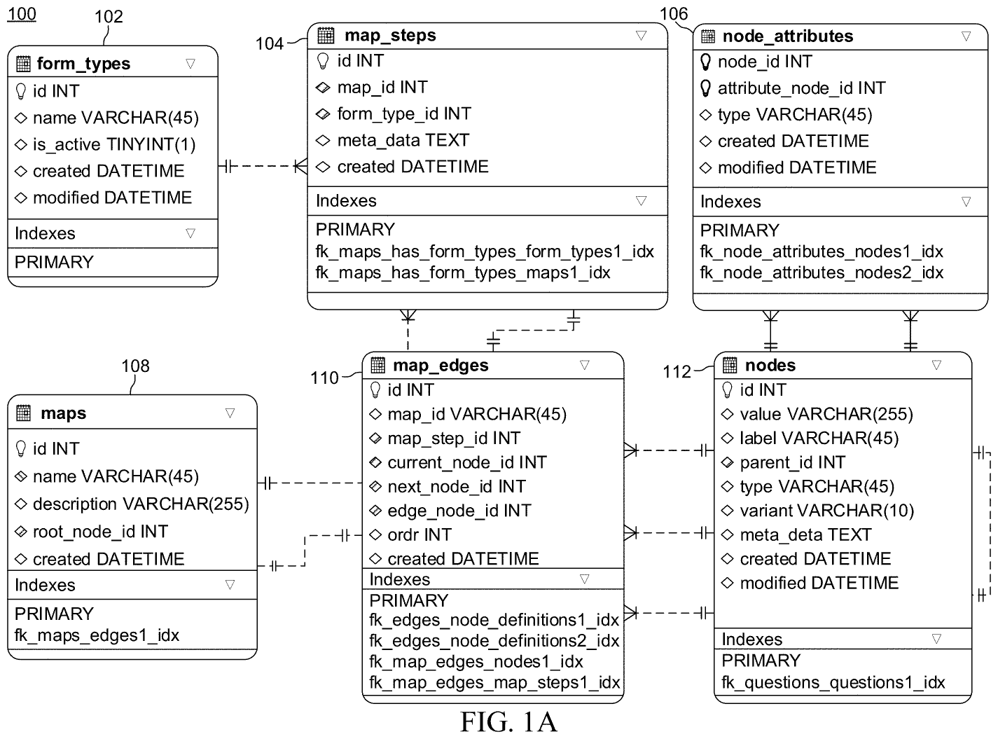

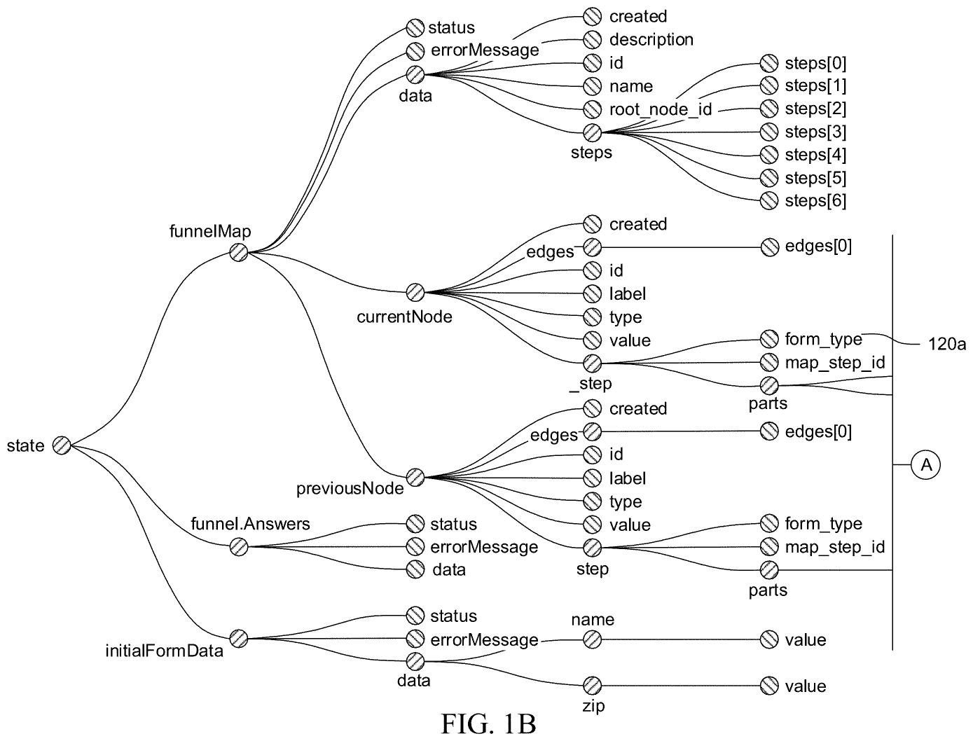

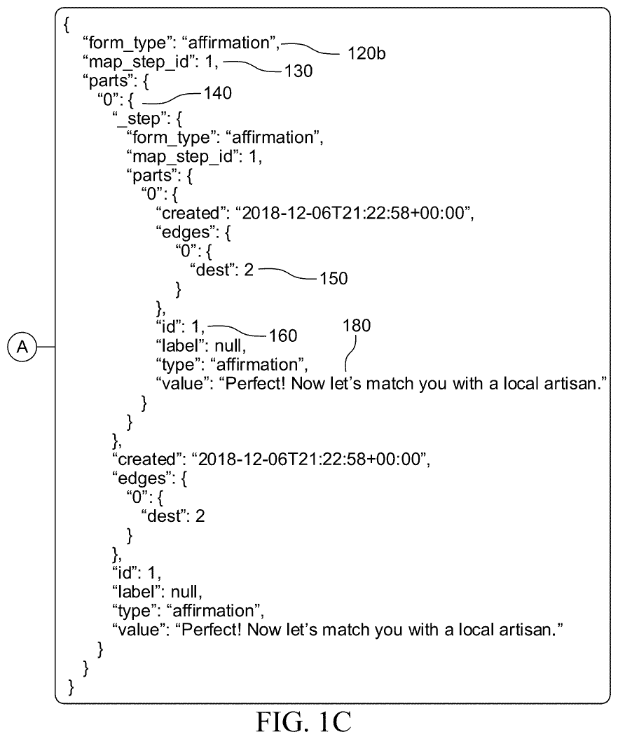

Referring now to the drawings in which like numerals represent the same or similar elements and initially to FIG. 1A, a block diagram of a data structure and relationships of the elements thereof is provided in accordance with an embodiment of the present invention. Block 102 can be understood to be a form_types table that includes meta data that directs the front-end of an application to identify which templates to use for presentation to a user. Block 104 can be understood to be a map_steps table which groups the data for each step or stage presented to a user (e.g., for each page displayed to a user). The “shape” that these pages take can be governed by the forms/templates of block 102. Block 110 can be understood to be a map_edges table that connects the “current”, “through”, and “next” nodes that are presented according to the groupings of block 104. Block 108 can be understood to be a maps table that defines the collection of map_edges of block 110 into an implementation as an odyssey map that a user can traverse. Block 112 can be understood to be a nodes table that defines and manages all the nodes and includes all of their respective attributes such as aliases and variants that are connected to each other via the aforementioned parent_id.

Turning now to FIG. 1B, a diagram for a given node in an embodiment, and FIG. 1C, a diagram of an exemplary JavaScript Object Notation (JSON) file including the information for a node of block 112 of FIG. 1A, is provided. The node can have an indicator of a form type 120a that can be represented by JSON line 120b. The indicator can indicate the type of node that a particular node is. JSON line 130 provides an indication to the front end of an application of an embodiment of the invention what step the node is a part of and how to display it. JSON line 140 indicates that the instant step contains only 1 part. JSON line 150 indicates the node id of the next node. JSON line 160 indicates the ID of the instant node. JSON line 180 provides the human-readable value (e.g., text) of the node. It should be understood that this information can be encoded in other formats as well.

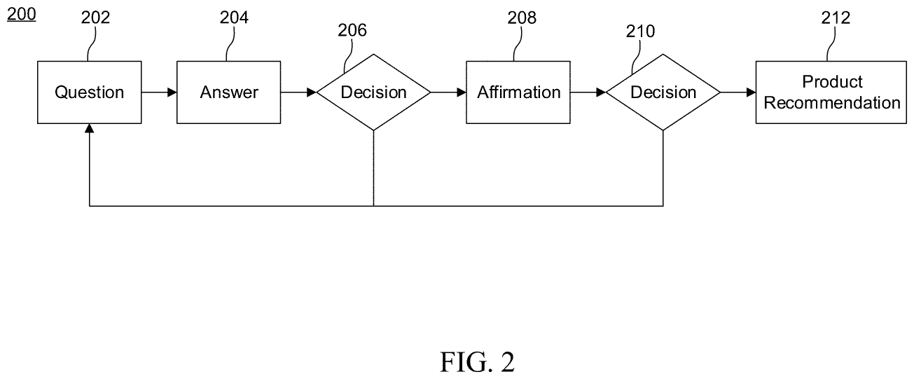

Turning now to FIG. 2, an exemplary flow diagram of a method 200 in accordance with an embodiment of the present invention is provided. Initially, a question can be presented to a user at the beginning of the iterative interactive experience, in block 202. Next, an answer can be collected from a user, for example by receiving a user selection, user input, or a combination of a selection and data entry, in block 204. Thereafter, a decision can be made about the next step in the experience by identifying the “next” node by reference to the map_edges table, in bBlock 206. It should be understood that the decision can be based on a user's interaction and the particular odyssey map that the user is traversing. At this point, the user may be returned to another question block and be taken through another iteration of the process of blocks 202-206, or, alternatively, continue to block 208. At block 208, an affirmation can be provided to a user based on the user's previous interaction (e.g., answer provided in block 102). Thereafter, a decision can be made about the next step in the experience by identifying the “next” node by reference to the map_edges table (Block 210). At this point the user may be returned to another question block and be taken through another iteration of the process of blocks 202-210, or, alternatively, continue to block 212. At block 212, the user can be provided with a suggestion or a recommendation (e.g., a recommendation of a product or service) based on the collection of all of the user interactions (e.g., answers) from the user in the previous blocks.

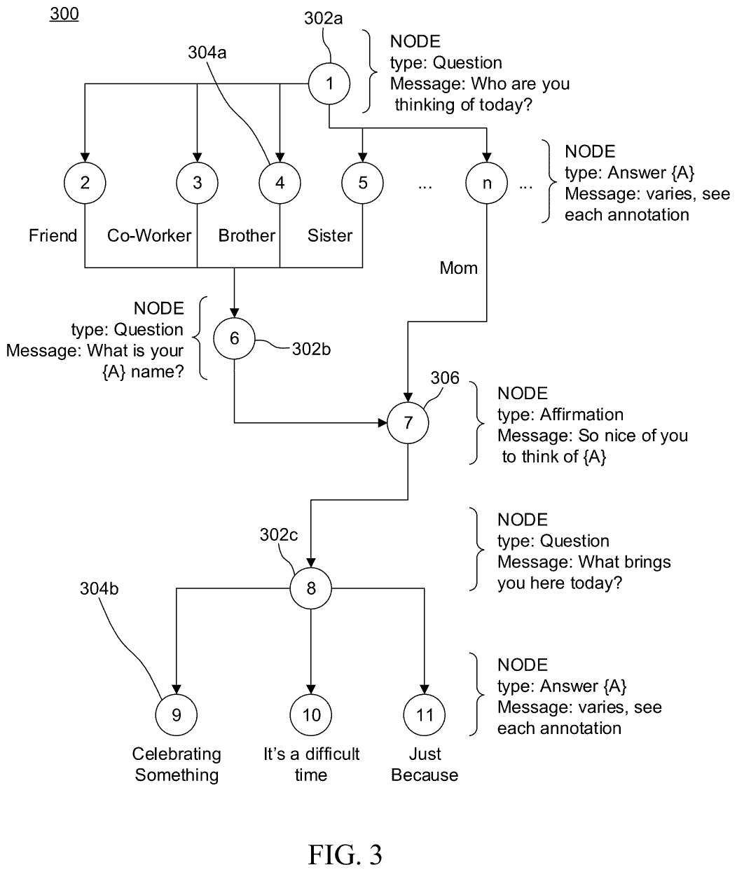

With reference to FIG. 3, an exemplary flow diagram of a traversal of routes of an odyssey map, in accordance with an embodiment of the present invention is provided. Node 1 is an example of a question node 302a that presents the question “Who are you thinking of today”. The user can then make enter a response or make selections such as the ones of answer nodes 2-n to provide an answer 304a “{A}”, respectively labeled as Friend, Co-Worker, Brother, Sister and Mom. From answer nodes 2-5 the user can then be taken to another question node 6 302b that presents the question of “What is your {A} name?” depending on the previous answer provided. From node n 304a or node 6 302b, the user can continue on to affirmation node 7 306 which presents the user with the affirmation “So nice of you to think of {A}” (where {A} in this case would be Mom). From node 7 306 the user can proceed to another question node 8 302c, which can present the user with another question such as “What brings you here today?” to which a user can respond by exemplary nodes 9-11 304b, respectively indicating “Celebrating Something”, “It's a difficult time”, and “Just Because”.

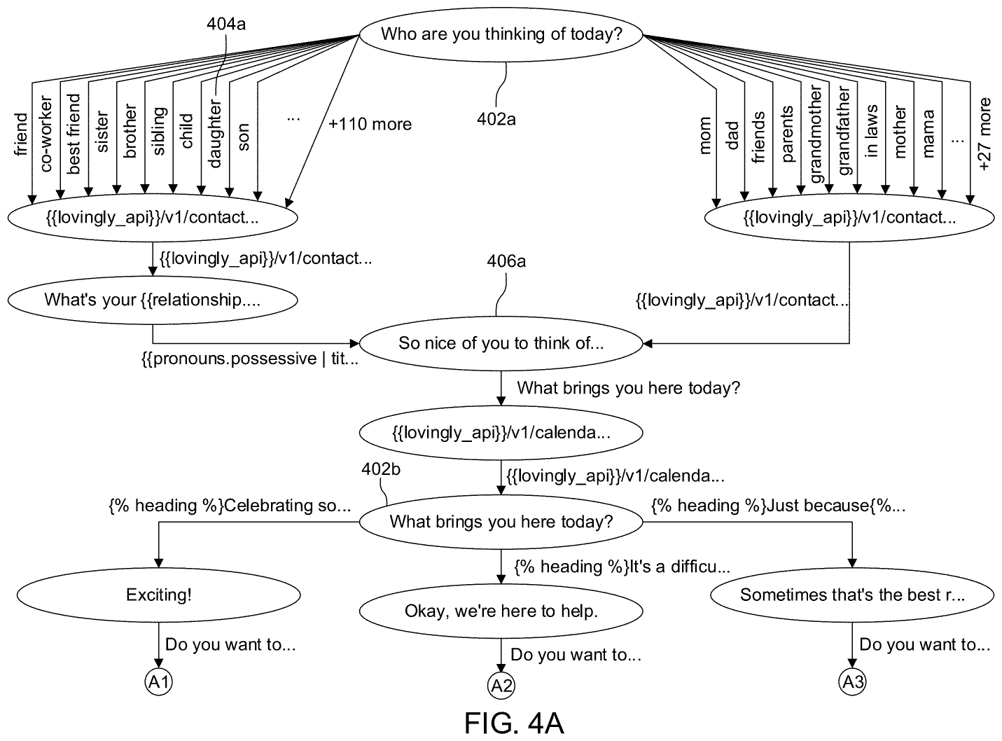

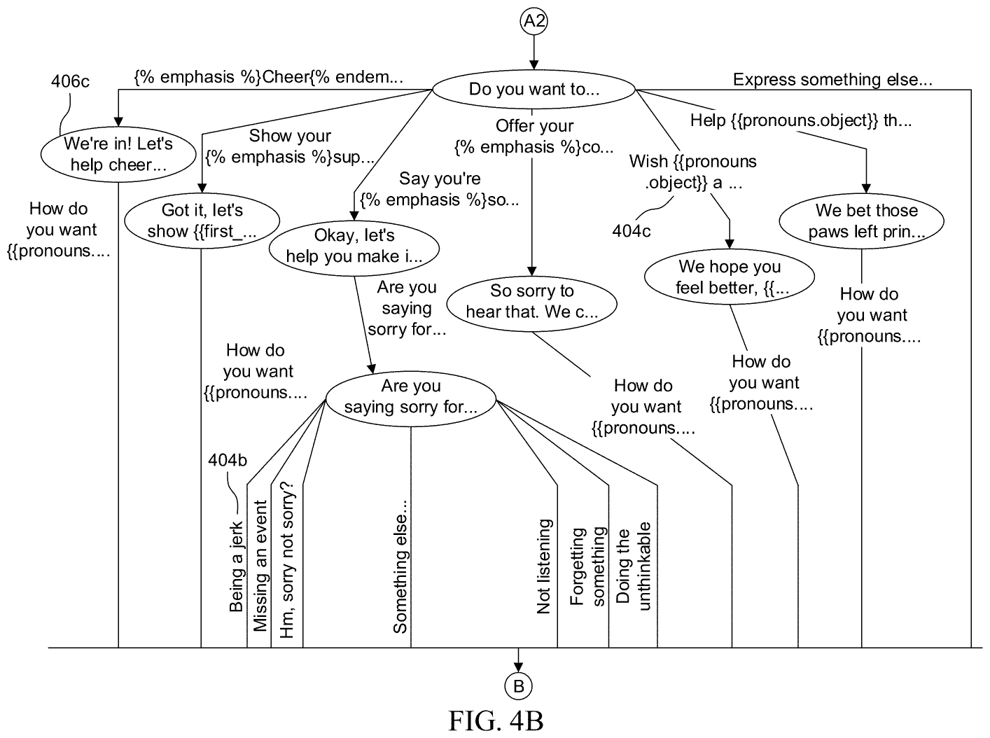

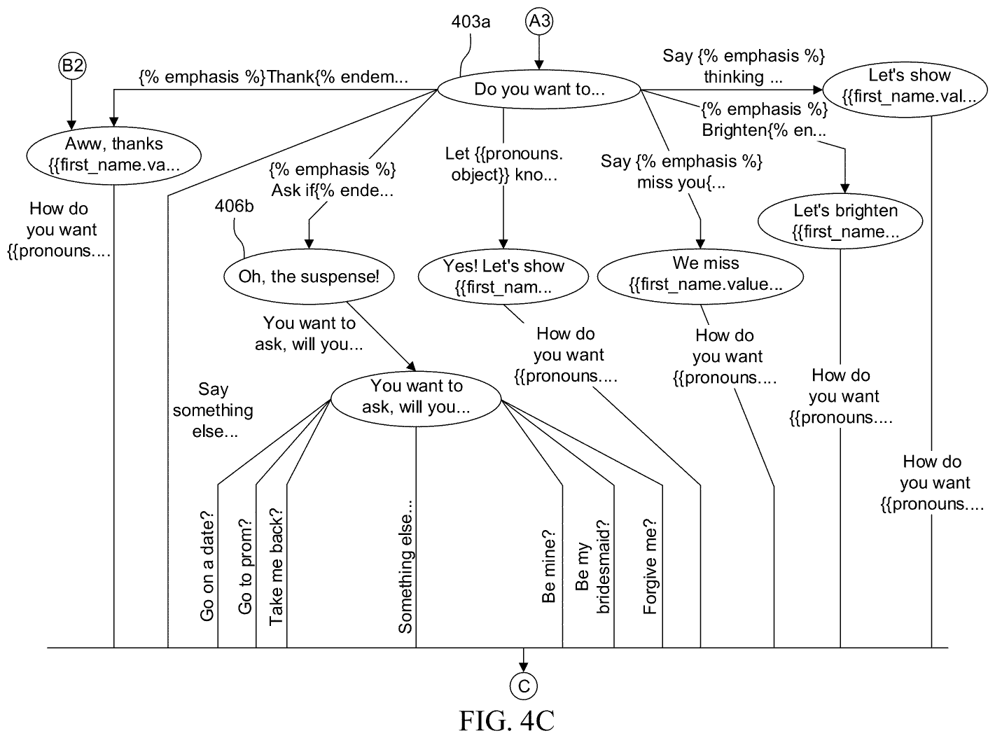

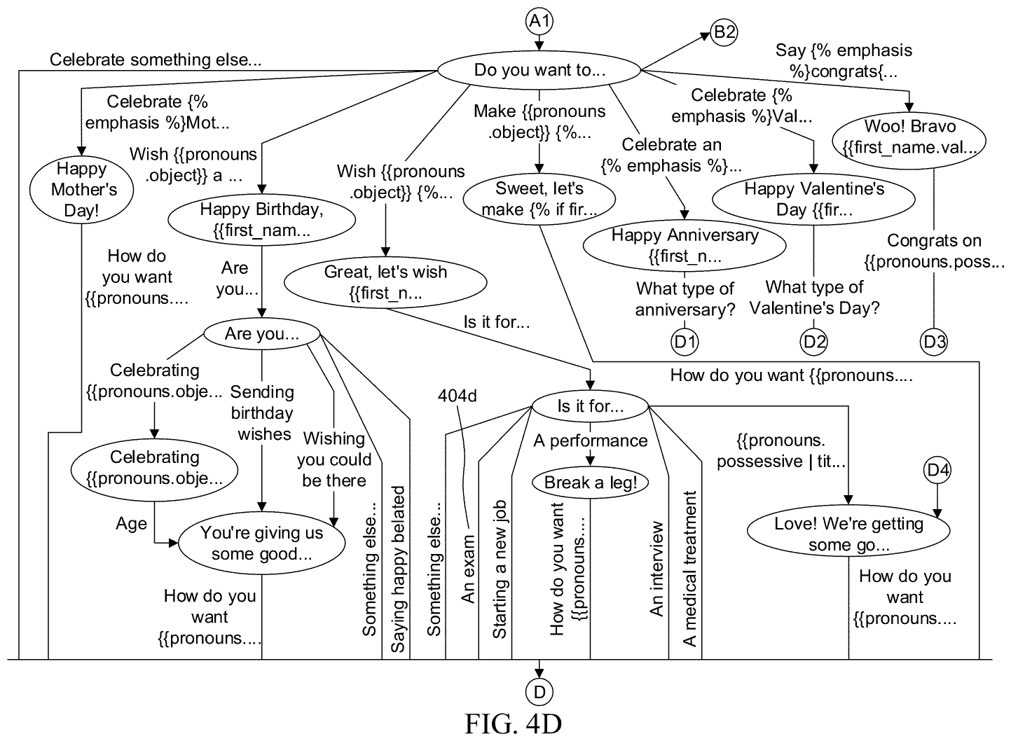

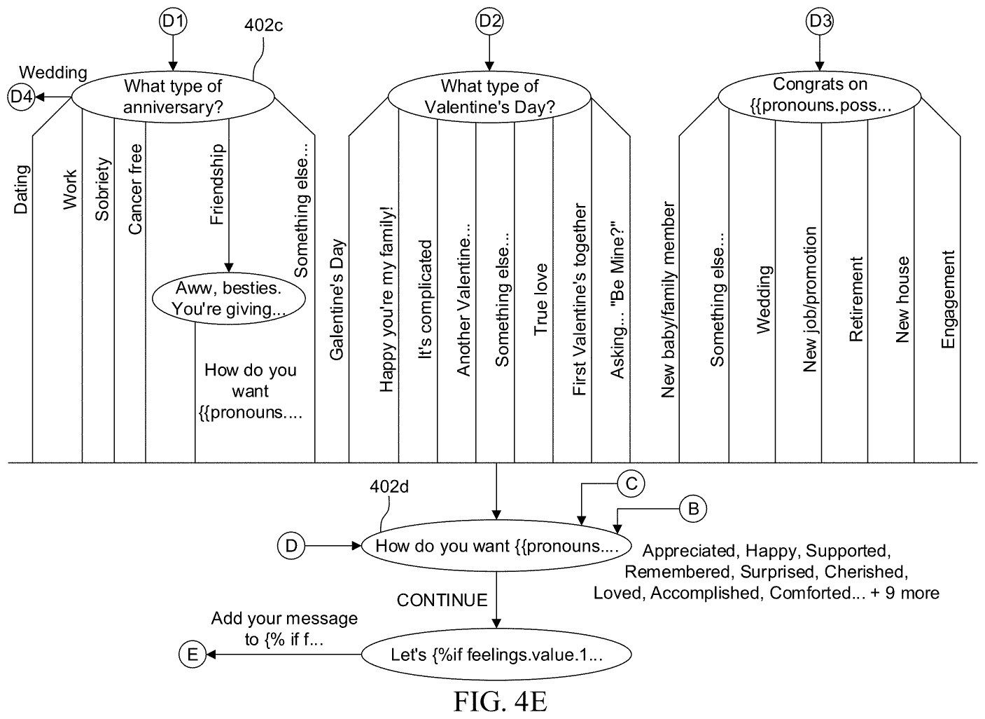

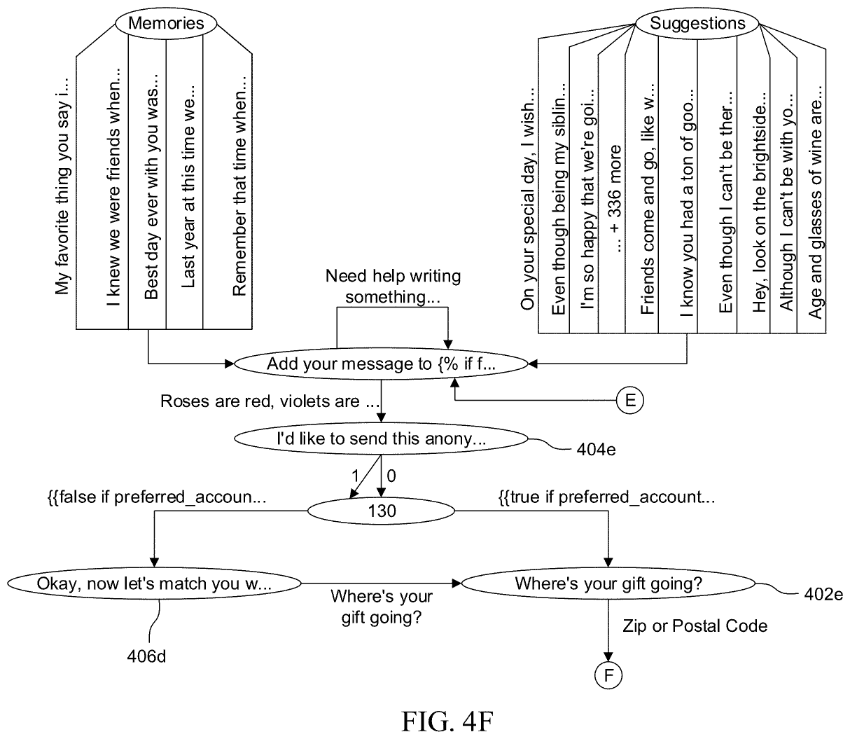

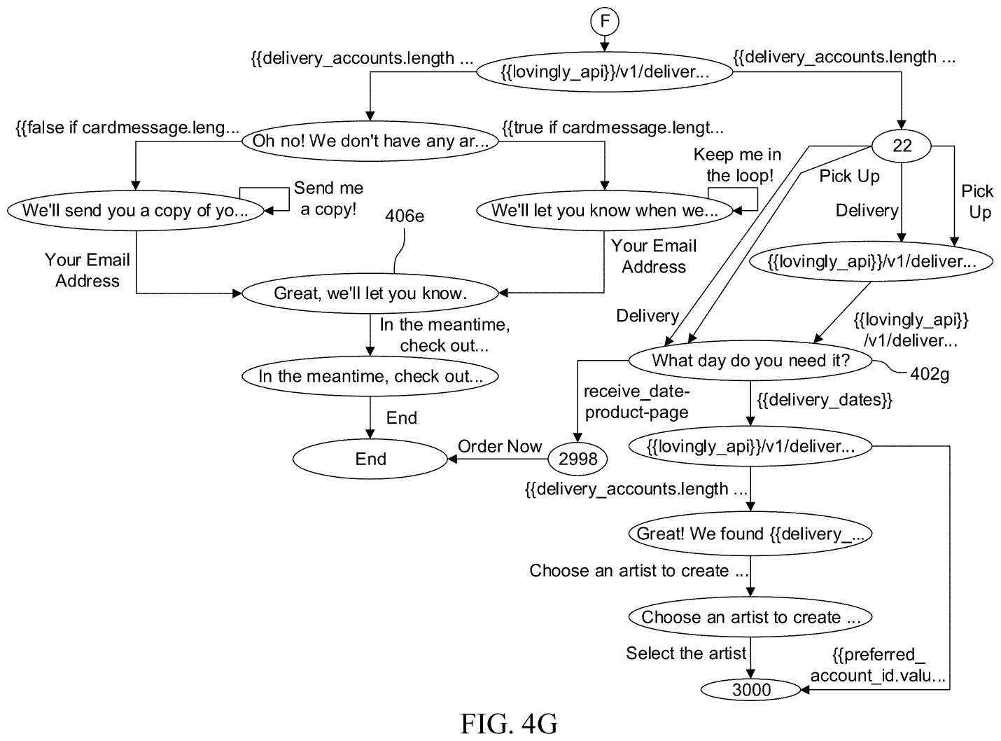

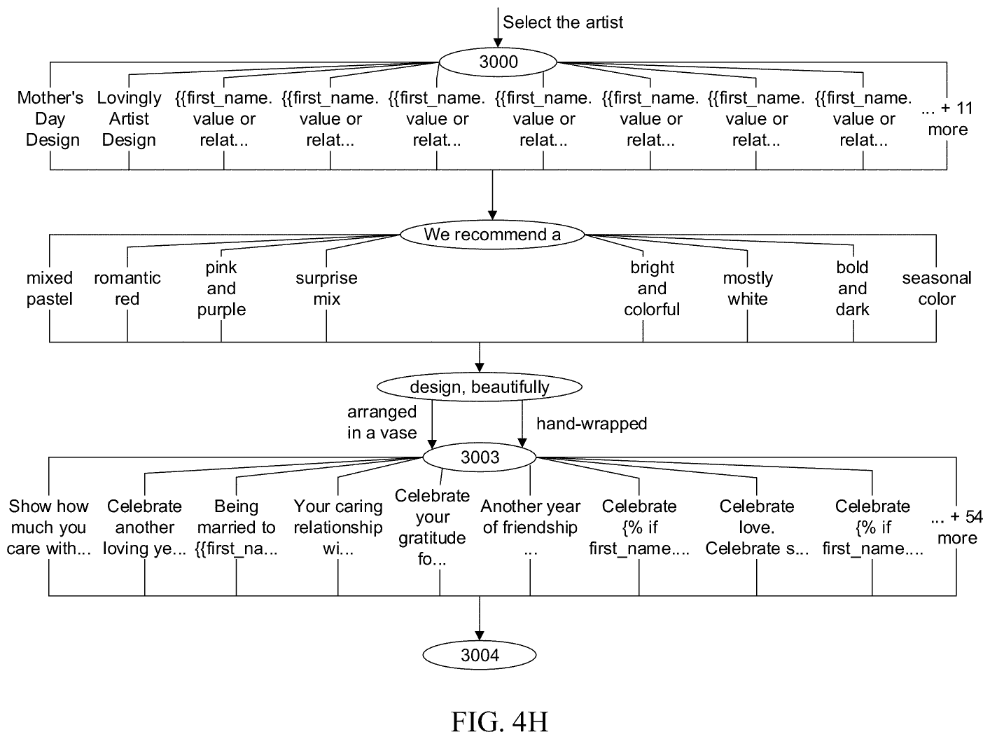

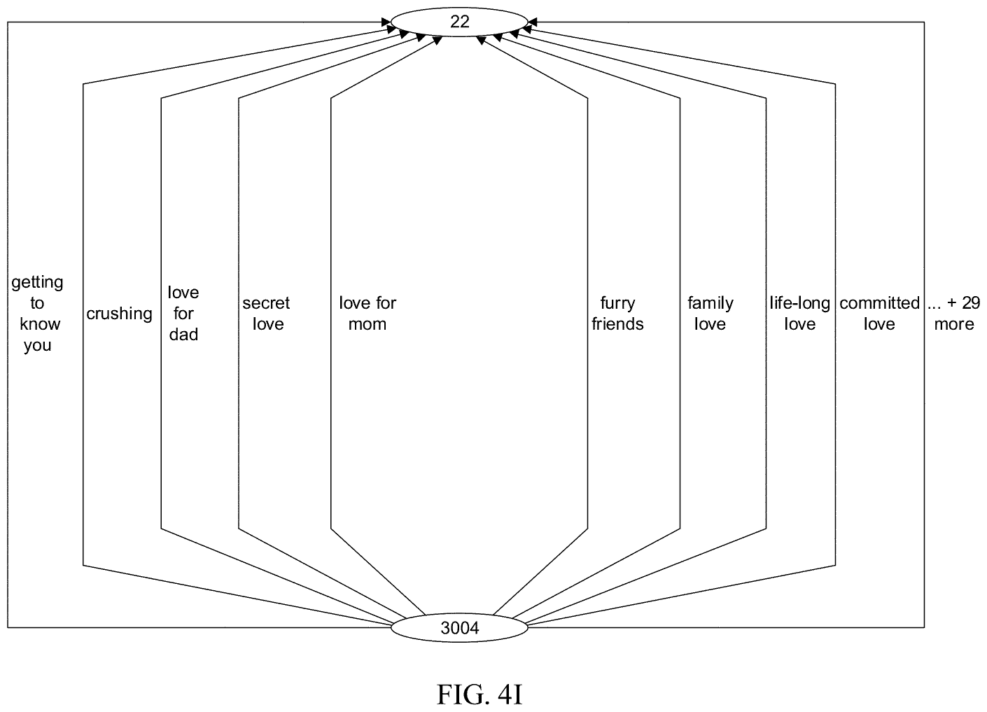

FIGS. 4A-I respectively depict portions of a diagram of an exemplary odyssey map, in accordance with an embodiment of the present invention traversed analogously to the nodes of FIG. 3. FIGS. 4A-I depict a variety of each type, question, answer, and affirmation nodes as well as the order in which a user can traverse them. The various potential paths and traversal routes end in FIG. 4G with a suggested/recommended product or service being provided to and selected by the user.

For example, FIG. 4A shows a sample question node 402a being followed by an answer of “daughter” within a subsequent answer node 404a which, then leads the user to the affirmation node 406a which states “so nice of you to think of your daughter”. Subsequently the odyssey map leads the user to the question node 402b which asks “What brings you here today?”. Further, FIG. 4B shows that a user following the exemplary odyssey map may proceed to an affirmation node 406c stating “We're in! lets help cheer . . . ” or an answer node 404c indicating a desire to wish something to someone. Alternatively, in node answer 404b a user may indicate that they want to say sorry for a particular reason. Additionally, as seen in FIG. 4C, a user may respond to question node 403a and be prompted with the affirmation of “Oh, the suspense!” in affirmation node 406b. Alternatively, a user traversing the odyssey map may indicate the desire to wish something to someone for an exam in answer node 404d. The user may continue to be prompted with questions such as the one in question nodes 402c and 402d shown in FIG. 4E and node 402e in FIG. 4F. The user may also provide additional responses while traversing the odyssey map such as the indication that the user would like to send something anonymously provided in node 404e and receive an affirmation regarding matching the user with a provider in affirmation node 406d as seen in FIG. 4F. FIG. 4G shows the conclusion of the various possible paths that can be traversed in the odyssey map as well as the affirmation “Great, we'll let you know.” in affirmation node 406e and the question “What day do you need it?” in question node 402g. Alternative paths with their respective nodes leading from element 3000 back to element 22 are shown in FIGS. 4H-4I.

The above described methods of the embodiments of the present invention can be performed on and the systems described herein can be embodied in a single computing device, a set of interlinked computing devices, or embodied as computer readable and/or executable instructions on a non-transitory computer readable medium. It should be understood that the computer readable program instructions may execute entirely on a user's computing device, partly on the user's computing device, as a stand-alone software package, partly on the user's computer and partly on a remote computing device (e.g., a server), or entirely on a remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

According to an exemplary embodiment of the invention, data may be transferred to the system, stored by the system and/or transferred by the system to users of the system across LANs (e.g., office networks, home networks) or WANs (e.g., the Internet). In accordance with such an embodiment, the system may be comprised of numerous computing devices and/or numerous servers communicatively connected across one or more LANs and/or WANs. For example, there may be a hand-held computing device being operated by a user to send input and selections via the internet to a server to generate a series of questions/prompts of the steps of the interactive process on the display of the hand-held device. Alternatively an audio computing device can be operated by a user's voice to send input and selections via the internet to a server to generate the steps or stages of the iterative interactive process to be presented to a user via audio. One of ordinary skill in the art would appreciate that there are a variety of ways in which the system could be configured, and embodiments of the invention are contemplated for use with any such configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). For example, a user may be operating a tablet device to input responses and selections while iteratively being presented with prompts/questions to traverse the odyssey map without needing the tablet to be connected to the internet. Therefore, in some embodiments, some of its applications, features, or functions may not be accessible when not connected to a network, however a user or a module/component of the system itself may be able to compose, combine, or generate data offline from the remainder of the system that will be consumed by the system or its other components when the user/offline system component or module is later connected to the system network.

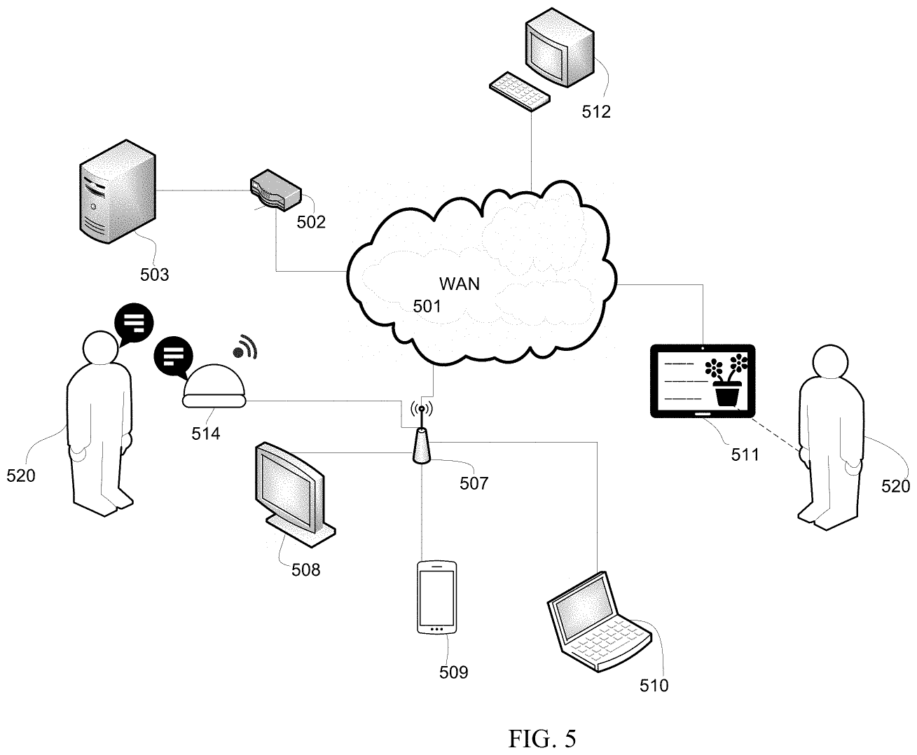

Referring to FIG. 5, a schematic overview of a system in accordance with an embodiment of the invention is shown. The system can be comprised of one or more application servers 503 for electronically storing information used by the system. Applications in the server 503 may retrieve and manipulate information in storage devices and exchange information through a WAN 501 (e.g., the Internet). Applications in server 503 may also be used to manipulate information stored remotely and process and analyze data stored remotely across a WAN 501 (e.g., the Internet).

According to an exemplary embodiment, as shown in FIG. 5, exchange of information through the WAN 501 or other network may occur through one or more high speed connections. In some cases, high speed connections may be over-the-air (OTA), passed through networked systems, directly connected to one or more WANs 501 or directed through one or more routers 502. One of ordinary skill in the art would appreciate that there are numerous ways server 503 may connect to WAN 501 for the exchange of information, and various embodiments of the invention are contemplated for use with any method for connecting to networks for the purpose of exchanging information.

Components, elements, or modules of the system may connect to server 503 via WAN 501 or other network in various ways. For instance, a component or module may connect to the system (i) through a computing device 512 directly connected to the WAN 501, (ii) through a computing device connected to the WAN 501 through a routing device 502, (iii) through a computing device 508, 509, 510, 514 connected to a wireless access point 507, or (iv) through a computing device 511 via a wireless connection (e.g., WiFi, CDMA, GMS, 3G, 4G, 5G, other suitable means, and means not yet invented) to the WAN 501. One of ordinary skill in the art will appreciate that there are numerous ways that a component or module may connect to server 503 via WAN 501 or other network, and embodiments of the invention are contemplated for use with any method for connecting to server 503 via WAN 501 or other network. Furthermore, server 503 could be comprised of a personal computing device, such as a smartphone or tablet, acting as a host for other computing devices to connect to.

Users 520 of the system, in accordance with embodiments of the invention, can interact with the system via computing devices such as a laptop 510, personal computers 508, cell phones/smart phones 509, tablets 511, smart speakers 514, smart TVs, smart hubs, smart kiosks, and the like. Each of the abovementioned steps and aspects can be performed via the input and output means of these respective devices including presentation of software user interface elements, presentation of prompts, questions, or affirmations (as embodied in the variety of nodes discussed above) to the user, collection of user input, presentation of options, suggestions, and recommendations, as well as the subsequent presentation of recommended courses of action, products, or services. For example, a user 520 can operate a tablet 511 to navigate to a browser interface presenting a web-based version of the software interface of an embodiment of the invention and be presented with prompts and questions on the screen of the laptop in response to which the user can provide inputs via the touchscreen of the tablet.

Consequently, the tablet 511 can present the user with the nodes in accordance with the user's previously provided interaction by processing the user input locally or having it, in whole or in part, be sent to be processed on a remote device such as a server, to then have a customized recommendation be generated on the screen of the tablet 511. It should be understood that the user can interact with the software interface of the invention by engaging user interface elements and entering input through a touch-screen of the tablet 511.

Alternatively, in an embodiment of the invention incorporating an audio device such as a smart speaker 514, a user can initialize an audio software interface to receive audio output and provide audio input to interact with the interface elements. For example, upon initializing a smart speaker 514 application version of the invention, user 520 can be presented with prompts, questions and other requests for input or selections via the audio output a smart speaker 514 (e.g., through statements or questions being presented through a voice emanating from the smart speaker 514). Thereafter, the user 520 can provide input in response to the prompts/question and make selections from among the options and suggestions via voice input. In this manner, the odyssey pattern and the routes thereof can be traversed by voice interaction.

It will be appreciated that the aforementioned collection of user input or response information can be realized through the use of image capture devices (e.g., camera(s) on a smart phone 509, laptop 510, tablet 511, computer 505 configured with a webcam, smart hubs, smart kiosks etc.) included in a system or device in accordance with an embodiment of the invention. Analogously, the collection of voice information in accordance with the various embodiments can be performed through the use of a microphone or other suitable sound capture and recording device that may be included on a variety of devices such as a smart phone 509, laptop 510, tablet 511, computer 505, a smart speaker 514, and the like.

The communications means of the system, according to embodiments of the present invention, may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the invention, and embodiments of the invention are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect. It should be understood that a programmable apparatus or computing device can include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this specification and elsewhere, a computing device can include any and all suitable combinations of at least one general purpose computer, special-purpose computer, programmable data processing apparatus, processor, processor architecture, and so on.

Any combination of one or more computer readable medium(s) may be utilized with the various embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a static random access memory (SRAM), a digital versatile disk (DVD), and any suitable combination of the foregoing.

Computer readable program instructions described herein can be downloaded to respective computing/processing devices from a computer readable storage medium or to an external computing device or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The flowchart and block diagrams in the Figures illustrate the architecture, functionality, and operation of possible implementations of systems, methods, and computer program products according to the various embodiments hereof. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

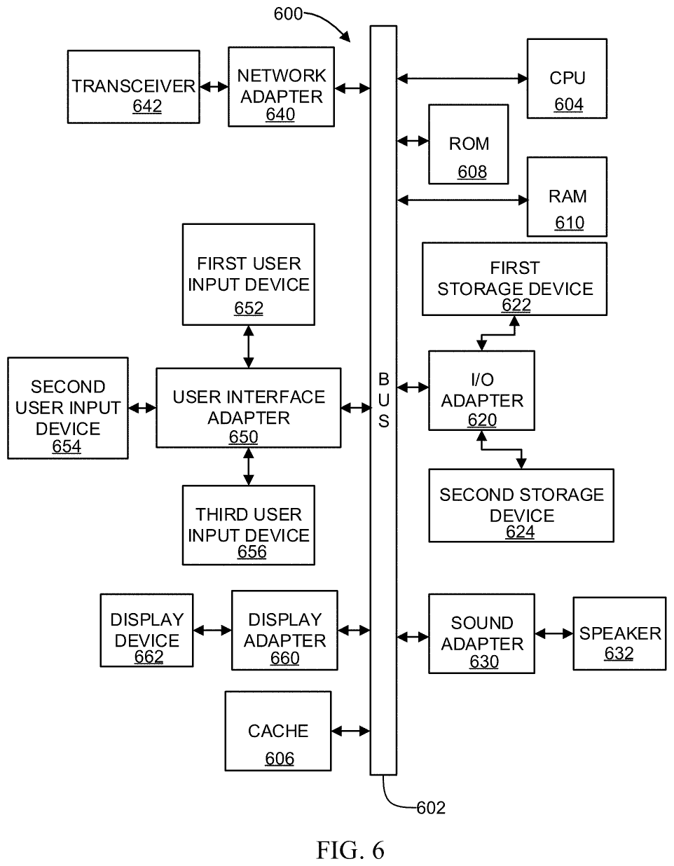

As noted earlier, the methods described above as well as the exemplary web-interface based system may be implemented on a variety of computing devices or processing systems. An illustrative representation of an exemplary computing device/processing system in accordance with an embodiment of the present invention is shown in FIG. 6. The computing device 600 can generally be comprised of a Central Processing Unit (CPU) 604 operatively coupled to other components via a system bus 602, optional further processing units including a graphics processing unit (GPU), a cache, a Read Only Memory (ROM) 608, and a Random Access Memory (RAM) 610. The computing device 600 can also include an input/output (I/O) adapter 620, a sound adapter 630, a network adapter 640, a user interface adapter 650, and a display adapter 660, all of which may be operatively coupled to the system bus 602.

Additionally, a first storage device 622 and a second storage device 624 can be operatively coupled to system bus 602 by the I/O adapter 620. The storage devices 622 and 624 can be any of a disk storage device (e.g., a magnetic or optical disk storage device), a solid state storage device, and so forth. It should be appreciated that the storage devices 622 and 624 can be the same type of storage device or different types of storage devices. In instances where the device 600 is embodied by a smart speaker 214 or the like, it can incorporate a speaker 632 which may be operatively coupled to system bus 602 by the sound adapter 630. A transceiver 642 may be operatively coupled to system bus 602 by network adapter 640. In instances where the device 600 is embodied by a tablet 511 or a smart phone 509, it can include a display device 662 which may be operatively coupled to system bus 602 by display adapter 660.

In some embodiments, the device 600 may include a mother board, alternatively/additionally a different storage medium (e.g., hard disk drive, solid state drive, flash memory, cloud storage), an operating system, one or more application software and one or more input/output devices/means, including one or more communication interfaces (e.g., RS232, Ethernet, Wifi, Bluetooth, USB). Accordingly, in some embodiments a first user-input device 652, a second user-input device 654, and a third user-input device 656 may be operatively coupled to system bus 602 by user interface adapter 650. The user-input devices 652, 654, and 656 can be any of a keyboard, a mouse, a keypad, an image capture device (e.g., a camera), a motion sensing device, a microphone, a touch-sensitive device (e.g., a touch screen or touchpad), a device incorporating the functionality of at least two of the preceding devices, and so forth. Of course, other types of input devices can also be used, while remaining within the scope and spirit of the present invention. The user-input devices 652, 654, and 656 can be the same type of user-input device or different types of user-input devices. The user-input devices 652, 654, and 656 may be used to input and output information to and from system 600.

Thus, the prompts, questions, and affirmations discussed above may be presented to the user via the output means of exemplary device 600 in accordance with the embodiments of the present invention. Whether visually via a display device 662, audibly via speaker 632, or through a combination of both, a user can be prompted to respond to questions, enter input, or make selections in accordance with an embodiment of the invention. Accordingly, whether through tactile, audio, or video input through input devices 652, 654, and 656 a user can provide the input and selections to interact with the various elements and aspects of the invention to provide the information used for ascertaining a user's emotional goal and providing recommendations regarding the fulfillment of that emotional goal.

Of course, the processing system/device 600 may also include other elements (not shown), as readily contemplated by one of skill in the art, as well as omit certain elements. For example, various other input devices and/or output devices can be included in processing system 600, depending upon the particular implementation of the same, as readily understood by one of ordinary skill in the art. For example, various types of wireless and/or wired input and/or output devices can be used and additional processors, controllers, memories, and so forth, in various configurations can also be utilized as readily appreciated by one of ordinary skill in the art. These and other variations of the processing system 600 are readily contemplated by one of ordinary skill in the art given the teachings of the embodiments provided herein.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

It will be appreciated that computer program instructions may include computer executable code. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including a functional programming language such as python, an object oriented programming language such as SMALLTALK, C++ or the like, and conventional procedural programming languages, such as the “C” programming language or similar programming languages. A variety of languages for expressing computer program instructions are possible, including without limitation, Java, JavaScript, JavaScript Object Notation (JSON), assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

As employed herein, the term “hardware processor subsystem”, “hardware processor”, “processing device”, or “computing device” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps.

Throughout this specification and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

1. A system for interacting with a user, comprising:
a processor operatively coupled to a storage device having a data structure defining an odyssey map recorded therein, the data structure comprising:
a plurality of nodes of different types, each node being associated with an indication of node type;
a route defined in terms of an ordered sequence of nodes including a current node, a through node, and a next node, wherein a traversal of the route by a user interacting with the plurality of nodes concludes with a presentation of a recommendation to the user; and
instructions for presenting contents of a node via a human interface device.

2. The system of claim 1, wherein each node is further associated with a human readable value or a machine readable value.

3. The system of claim 1, wherein each node is further associated with an identification of its parent value.

4. The system of claim 1, wherein a connection between two nodes of the plurality of nodes is recorded in a routing table having a column indicating the current node, a column indicating the through node, and a column indicating the next node.

5. The system of claim 1, wherein information for each node is recorded as a JavaScript Object Notation (JSON) file.

6. The system of claim 1, wherein the route is defined by a combination of node IDs with each node ID designating the current node, the next node, or the through node, and is further defined by an order by which the node IDs are associated between each other.

7. The system of claim 1, wherein the processor is configured to aggregate input of the user.

8. The system of claim 1, wherein each node is a question node, an answer node, or an affirmation node.

9. The system of claim 1, further comprising at least one of each of a question node, an answer node, and an affirmation node.

10. The system of claim 1, wherein the recommendation is of a product or service.

11. A non-transitory computer readable storage medium comprising a computer readable program for creating an odyssey map traversable by a user, wherein the computer readable program when executed on a computing device causes the computing device to generate a data structure, the data structure comprising:
a plurality of nodes of different types, each node being associated with an indication of node type;
a route defined in terms of an ordered sequence of nodes including a current node, a through node, and a next node, wherein a traversal of the route by a user interacting with the plurality of nodes concludes with a presentation of a recommendation to the user; and
instructions for presenting contents of a node via a human interface device.

12. A non-transitory computer readable storage medium of claim 11, wherein each node is further associated with a human readable value or a machine readable value.

13. A non-transitory computer readable storage medium of claim 11, wherein each node is further associated with an identification of its parent value.

14. A non-transitory computer readable storage medium of claim 11, wherein a connection between two nodes of the plurality of nodes is recorded in a routing table having a column indicating the current node, a column indicating the through node, and a column indicating the next node.

15. A non-transitory computer readable storage medium of claim 11, wherein information for each node is recorded as a JavaScript Object Notation (JSON) file.

16. A non-transitory computer readable storage medium of claim 11, wherein the route is defined by a combination of node IDs with each node ID designating the current node, the next node, or the through node, and is further defined by an order by which the node IDs are associated between each other.

17. A non-transitory computer readable storage medium of claim 11, wherein the computer readable program when executed on a computing device further causes the computing device to aggregate input of the user.

18. A non-transitory computer readable storage medium of claim 11, wherein each node is a question node, an answer node, or an affirmation node.

19. A non-transitory computer readable storage medium of claim 11, wherein the data structure comprises at least one of each of a question node, an answer node, and an affirmation node.

20. A non-transitory computer readable storage medium comprising a data structure representing an odyssey map, the odyssey map including:
a plurality of different node types, each node being associated with an indication of node type;
a route defined in terms of an ordered sequence of nodes including a current node, a through node, and a next node, wherein a traversal of the route by a user concludes with a presentation of a recommendation to the user; and
at least one of each of a question node, an answer node, and an affirmation node.
